(19) United States
(12) Patent Application Publication
(10) Pub. No.: US 2020/0096824 A1
(43) Pub. Date: Mar. 26, 2020

(54) METHOD FOR MANUFACTURING SUBSTRATE, DISPLAY PANEL AND METHOD FOR MANUFACTURING DISPLAY PANEL

(71) Applicants: HKC Corporation Limited, Shenzhen, Guangdong (CN); Chongqing HKC Optoelectronics Technology Co., Ltd., Chongqing (CN)

(72) Inventor: Chung-Kuang CHIEN, Chongqing (CN)

(21) Appl. No.: 16/495,714

(22) PCT Filed: Jul. 26, 2017
(86) PCT No.: PCT/CN2017/094555

§ 371 Date: Sep. 19, 2019

(30) Foreign Application Priority Data
Mar. 31, 2017 (CN) 201710206404.X

(51) Int. Cl. G02F 1/1337; G02F 1/1335; G02F 1/1339

(52) U.S. Cl. CPC G02F 1/133711; G02F 1/1339; G02F 1/133617; G02F 1/133788

(57) ABSTRACT

A method for manufacturing a substrate, a display panel and a method for manufacturing a display panel are disclosed. The method for manufacturing the substrate comprises: providing a substrate body forming an alignment layer on a surface of the substrate body, and forming a precursor layer on a surface of the alignment layer away from the substrate body. The leading material layer reacts with the alignment layer to form bonds therebetween.

### BACKGROUND

### Technical Field

This disclosure relates to a preparing method of a substrate, a display panel and a method for manufacturing the same.

### Related Art

Because flat panel displays, such as liquid crystal displays (LCD) and the like, have the advantages of high quality, power-saving, thin body and wide application, and are widely applied in various consumer electronic products, such as mobile phones, televisions, personal digital assistants, digital cameras, notebook computers, desktop computers, and etc., they become mainstream products among display devices.

Among technologies related with wide-viewing-angle panels, the technology of fine-slit alignment (FSA) is to provide a mixture, which comprises liquid crystal molecules and functional monomers mixed with the liquid crystal molecules, and, through irradiation with a light, to drive the functional monomers to react and bond with alignment film materials so as to orientate the liquid crystal molecules. However, in the aforementioned process, the functional monomers are required to be added among the liquid crystal molecules, which may tend to cause defects such as image retention owing to incomplete reaction of the functional monomers.

### SUMMARY

In view of the foregoing, this disclosure provides a method for manufacturing a substrate, a display panel and a method thereof, so as to overcome those defects and drawbacks caused by incomplete reaction of the functional monomers.

This disclosure provides a method for manufacturing a substrate, comprising the following step(s): forming an alignment layer on a surface of a substrate body, and, forming a precursor layer on a surface of the alignment layer away from the substrate body. The precursor layer reacts with the alignment layer to form bonds therebetween.

This disclosure also provides a display panel. The display panel comprises a first substrate, a second substrate and a liquid crystal layer. The first substrate comprises a first substrate body and a first alignment layer formed on the first substrate body. The second substrate is disposed opposite to the first substrate, and the second substrate comprises a second substrate body and a second alignment layer formed on the second substrate body. The liquid crystal layer is disposed between the first substrate and the second substrate. The first substrate further comprises a first precursor layer disposed on a surface of the first alignment layer away from the first substrate body, and the second substrate further comprises a second precursor layer disposed on a surface of the second alignment layer away from the second substrate body.

This disclosure also provides a method for manufacturing a display panel. The method comprises following steps: providing a first substrate body and a second substrate body; forming a first alignment layer on the first substrate body; cleaning the first alignment layer by a cleaning agent supplied with functional monomers, wherein the functional monomers are attached to a surface of the first alignment layer to form a first precursor layer after the first alignment layer is cleaned; forming a liquid crystal layer on the first precursor layer by way of one drop filling (ODF); adhering the first substrate body to the second substrate body by a sealant, wherein the first substrate body, the second substrate body and the sealant form a closed space, and the first precursor layer and the liquid crystal layer are disposed in the closed space; applying a first voltage between the first substrate body and the second substrate body; and irradiating the liquid crystal layer and the first precursor layer by a first light source.

In the method for manufacturing a substrate, the display panel, and the method for manufacturing a display panel provided by the present disclosure, functional monomers are supplied during the cleaning step which is performed before the ODF step. Such process is simple, and the functional monomers can be uniformly distributed accordingly.

### BRIEF DESCRIPTION OF THE DRAWINGS

The embodiments will become more fully understood from the detailed description and accompanying drawings, which are given for illustration only, and thus are not limitative of the present invention, and wherein:

FIG. 1 is a schematic flow chart showing a method for manufacturing a substrate according to an embodiment of this disclosure;

FIG. 2a is a schematic diagram showing an alignment layer formed on an substrate body according to the embodiment of this disclosure;

FIG. 2b is a schematic diagram showing that functional monomers are added to a surface of the alignment layer according to the embodiment of this disclosure;

FIG. 2c is a schematic diagram showing that functional monomers are treated to obtain a precursor layer according to the embodiment of this disclosure;

FIG. 3 is a schematic flow chart showing a method for manufacturing a display panel according to another embodiment of this disclosure;

FIG. 4 is a schematic diagram showing a first substrate and a second substrate according to the embodiment of this disclosure;

FIG. 5a is a schematic diagram showing that a liquid crystal layer is formed on the substrate so as to obtain a display panel according to the embodiment of this disclosure; and

FIG. 5b is a schematic diagram showing that the precursor layer reacts with the alignment layer to form bonds therebetween, so the liquid crystal layer is controlled to be pre-tilted according to the embodiment of this disclosure.

### DETAILED DESCRIPTION OF THE INVENTION

The embodiments of the invention will be apparent from the following detailed description, which proceeds with reference to the accompanying drawings, wherein the same references relate to the same elements. The following embodiments are used to exemplify the inventive concepts of the present disclosure and the present invention are not limited herein. In addition, for the convenience of description, the accompany drawings just depict those features related to and necessary for the description of the embodiments, instead of depicting fully structural details. Any feature in one of the following embodiments can be arbitrarily combined with those in other embodiments unless they are mutually exclusive.

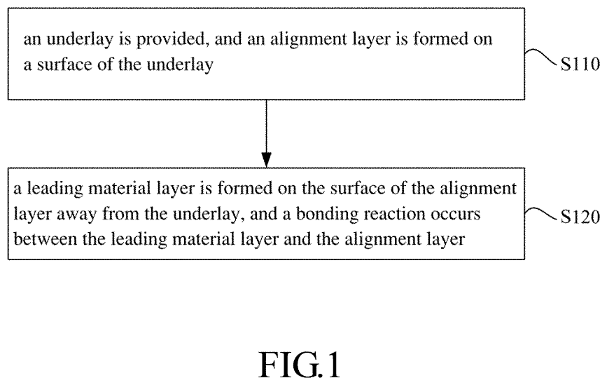

FIG. 1 is a schematic flow chart showing a method for manufacturing a substrate according to one embodiment of this disclosure. As shown in FIG. 1, the embodiment of this disclosure provides a method for manufacturing a substrate. The method comprises the following steps S110 and S120.

In step S110, a substrate body is provided, and an alignment layer is formed on a surface of the underlay.

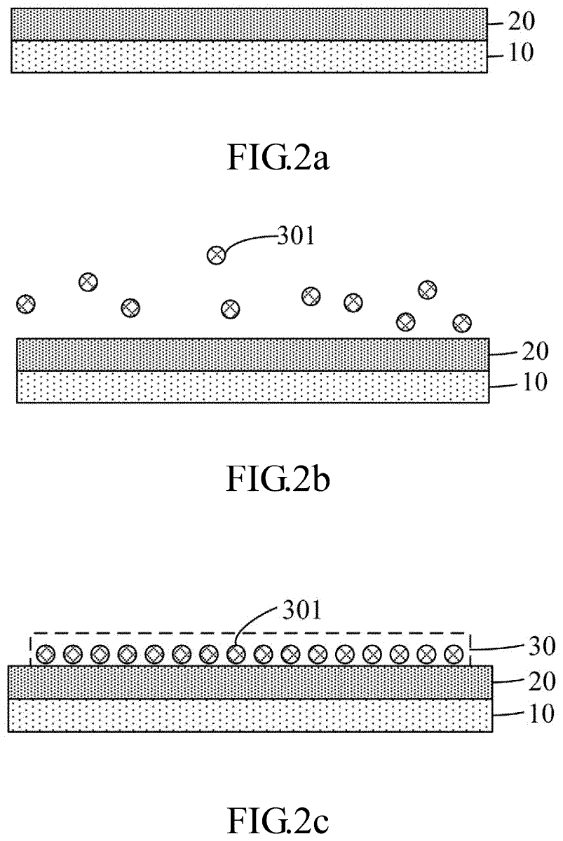

For example, FIG. 2a is a schematic diagram showing an alignment layer formed on a substrate body according to the present embodiment of this disclosure. As shown in FIG. 2a, a substrate body 10 is provided and an alignment layer 20 is formed on the substrate body 10. The substrate body 10 can be a flexible substrate body or a rigid substrate body. When the substrate body 10 is flexible, the substrate body 10 can be made by at least one species of the following materials: polyimide, polyethylene terephthalate, polyethylene naphthalate, polycarbonate, polyarylate, and polyethersulfone. When the substrate body 10 is rigid, the substrate body 10 can be made by glass or any other rigid material.

The alignment layer 20 can be formed on the substrate body 10 by coating (such as spraying or spin-coating) material(s) for the alignment film on the substrate body 10. Alternatively, the alignment layer 20 can be formed on the substrate body 10 by directly adhering an alignment film onto the substrate body 10. However, how to form the alignment layer 20 on the substrate body 10 is not limited in the present disclosure. Optionally, the alignment film can be made by at least one species of the following materials: polyimide, polyethylene terephthalate, polyethylene naphthalate, polycarbonate, polyarylate and polyethersulfone.

In step S120, a precursor layer is formed on the surface of the alignment layer away from the substrate body, and the precursor layer reacts with the alignment layer to form bonds.

For example, a precursor layer 30 is formed on the surface of the alignment layer 20, and said surface is away from the substrate body 10. The precursor layer 30 may react with the alignment layer 20 to form bonds, such that the liquid crystal molecules are controlled to be pre-tilted through the generated bonding grids.

Optionally, after the alignment layer 20 is formed on the surface of the underlay 10, the method for manufacturing the substrate may further comprise the following step: cleaning the alignment layer 20.

For example, the cleaning performed on the alignment layer 20 can remove impurities on the surface of the alignment layer 20. In detail, it can use a cleaning agent to clean the alignment layer 20, followed by drying the alignment layer 20 after the alignment layer 20 is cleaned.

Optionally, during the formation of the precursor layer 30 on the surface of the alignment layer 20 away from the substrate body 10, the method may comprise the following steps: supplying functional monomers 301 to the cleaning agent in the cleaning process of the alignment layer 20; and treating the functional monomers 301, such that the functional monomers 301 are assembled on the surface of the alignment layer 20 so as to form the precursor layer 30.

For example, supplying the functional monomers 301 into the cleaning agent used in the cleaning process of the alignment layer 20 may ensure that the functional monomers 301 are directly attached to the surface of the alignment layer 20 after the alignment layer is cleaned. The functional monomers 301 attached to the surface of the alignment layer 20 are treated, so as to form the precursor layer 30 uniformly distributed on the surface of the alignment layer 20.

Alternatively, during the formation of the precursor layer 30 on the surface of the alignment layer 20 away from the substrate body 10, the method may comprise the following steps: treating the surface of the alignment layer 20 after the alignment layer 20 is cleaned, followed by supplying the functional monomers 301 to said surface of the alignment layer 20; and treating the functional monomers 301, such that the functional monomers 301 are assembled on the surface of the alignment layer 20 so as to form the precursor layer 30.

For example, functional monomers 301 can be supplied onto the surface of the alignment layer 20 after the alignment layer 20 is cleaned and dried, and the functional monomers 301 may directly attach to said surface of the alignment layer 20. The functional monomers 301 attached to said surface of the alignment layer 20 are treated, such that the functional monomers 301 are assembled on the surface of the alignment layer 20 so as to form the precursor layer 30 which is uniformly distributed.

Optionally, FIGS. 2b and 2c are schematic diagrams showing that supplying the functional monomers onto the surface of the alignment layer and that treating the functional monomers so as to form a precursor layer, respectively, according to the present embodiment of this disclosure. As shown in FIGS. 2b and 2c, the functional monomers 301 are supplied onto the alignment layer 20, and are then treated to form the precursor layer 30 on said surface of the alignment layer 20. Optionally, the functional monomers can be made of photosensitive materials, and the functional monomers 301 comprises at least one species of the following materials: acrylates, acrylate derivatives, methacrylates, methacrylate derivatives, styrenes, styrene derivatives and epoxy resins.

Optionally, the method for manufacturing the substrate according to the present embodiment of this disclosure can be used to fabricate an array substrate as well as a color-filter substrate.

In the method for manufacturing the substrate provided by the present embodiment of this disclosure, the alignment layer 20 is formed on the substrate body 10 and the precursor layer 30 is formed on the surface of the alignment layer 20 away from the substrate body 10, such that the precursor layer 30 can react with the alignment layer 20 to form bonds therebetween, and the liquid crystal molecules positioned above the precursor layer 30 are pre-tilted. In addition, the functional monomers 301 are supplied in or after the cleaning process of the alignment layer 20, and the functional monomers 301 are treated to form the precursor layer 30, such that the precursor layer 30 can be directly formed on the surface of the alignment layer 20. In other words, the precursor layer 30 is not formed by supplying the functional monomers 301 into the liquid crystal molecules. Such method is simple, and the functional monomers may react completely. The precursor layer 30 are distributed uniformly. Therefore, the liquid crystal molecules are ensured to be aligned uniformly.

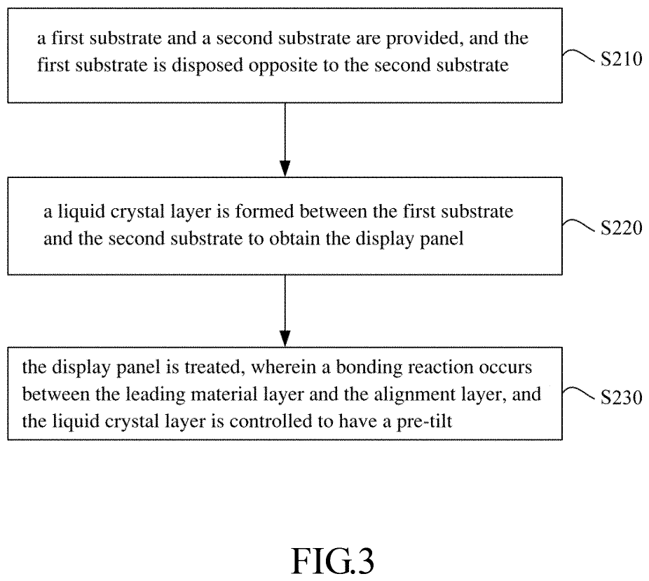

This disclosure further provides another embodiment which is a method for manufacturing a display panel. The method for manufacturing the display panel is based on the aforementioned method for manufacturing the substrate in the preceding embodiment. FIG. 3 is a schematic flow chart showing a method for manufacturing a display panel according to the present embodiment of this disclosure. As shown in FIG. 3, the method for manufacturing the display panel according to the present embodiment of this disclosure may comprise the steps S210 to S230.

In step S210, a first substrate and a second substrate are provided. The first substrate is disposed opposite to the second substrate.

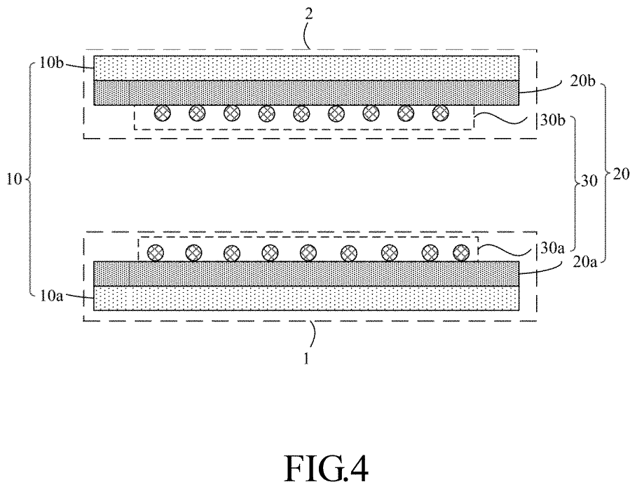

For example, FIG. 4 is a schematic diagram showing a first substrate and a second substrate according to the present embodiment of this disclosure. As shown in FIG. 4, a first substrate 1 and a second substrate 2 are provided. The first substrate 1 may be an array substrate of the display panel, and the second substrate 2 may be a color filter substrate of the display panel. Of course, the first substrate 1 may also be a color filter substrate of the display panel and the second substrate 2 may be an array substrate of the display panel. This disclosure is not particularly limited thereto.

Optionally, the first substrate 1 and/or the second substrate 2 can be manufactured and acquired through the aforementioned method for manufacturing the substrate provided by the preceding embodiment.

In detail, the first substrate 1 can be manufactured through the aforementioned method for manufacturing the substrate in the preceding embodiment. For example, the first substrate 1 may comprise a first substrate body 10a, a first alignment layer 20a and a first precursor layer 30a. The first alignment layer 20a is formed on the surface of the first underlay 10a. The first precursor layer 30a is disposed on the surface of the first alignment layer 20a away the first substrate body 10a. The second substrate 2 can also be fabricated by the aforementioned method for manufacturing the substrate in the preceding embodiment. For example, the second substrate 2 may comprise a second substrate body 10b, a second alignment layer 20b and a second precursor layer 30b. The second alignment layer 20b is formed on the surface of the second substrate body 10b. The second precursor layer 30b is disposed on the surface of the second alignment layer 20b away from the second substrate body 10b. Correspondingly, the substrate body 10 comprises the first substrate body 10a and the second substrate body 10b, the alignment layer 20 comprises the first alignment layer 20a and the second alignment layer 20b, and the precursor layer 30 comprises the first precursor layer 30a and the second precursor layer 30b.

Alternatively, one of the first substrate 1 and the second substrate 2 is fabricated by the method for manufacturing the substrate in the preceding embodiment. For example, the first substrate 1 is fabricated by the method for manufacturing the substrate in the preceding embodiment, and the second substrate 2 may be fabricated by the conventional method. in detail, the first substrate 1 may comprise the first substrate body 10a, the first alignment layer 20a which is formed on the surface of the first substrate body 10a and the first precursor layer 30a disposed on the surface of the first alignment layer 20a away from one side of the first substrate body 10a, whereas the second substrate 2 may comprise the second substrate body 10b and the second alignment layer 20b which is formed on the surface of the second substrate body 10b. The specific structural details of the first substrate 1 and the second substrate 2 are not limited in the present embodiment of this disclosure, but only at least one of these two substrates may comprise the precursor layer 30. Such configuration ensures that the precursor layer 30 is able to react with the alignment layer 20 so as to form bonds therebetween. The generated bonding grids can make the liquid crystal molecules to be tilted at a predetermined angle.

Optionally, the first substrate 1 is disposed opposite to the second substrate 2.

In step S220, a liquid crystal layer is formed between the first substrate and the second substrate, and the display panel is obtained.

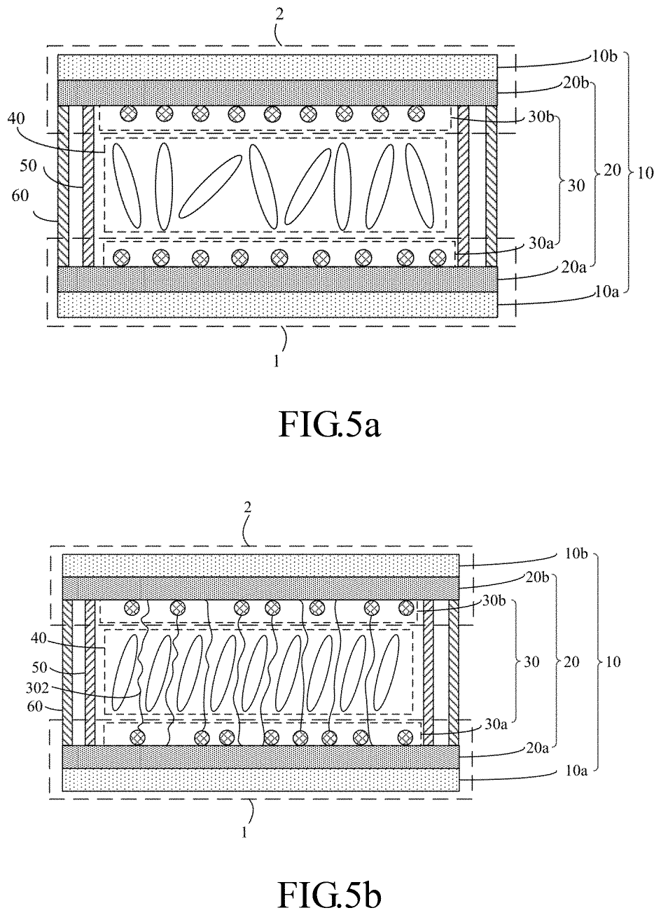

For example, FIG. 5a is a schematic diagram showing that a liquid crystal layer is formed on the substrate according to the present embodiment of this disclosure. As shown in FIG. 5a, a liquid crystal layer 40 is formed between the first substrate 1 and the second substrate 2. In detail, the liquid crystal layer 40 can be formed between the first substrate 1 and the second substrate 2 by way of one drop filling (ODF). In other words, the liquid crystal molecules are added dropwisely between the first substrate 1 and the second substrate 2 through the ODF process to form the liquid crystal layer 40.

Optionally, the liquid crystal molecules can be positive or negative dielectro-anisotropic.

Optionally, the method for manufacturing the display panel may further comprise the following steps: providing a sealant 50, and coating the sealant 50 on the first substrate 1 or the second substrate 2 corresponding to the periphery of the liquid crystal layer 40, followed by curing the sealant 50 such that the first substrate 1 and the second substrate 2 are adhered to each other through the sealant 50.

Optionally, the method for manufacturing the display panel may also further comprise the following steps: providing a conductive adhesive 60, and coating the conductive adhesive 60 on the first substrate 1 or the second substrate 2 corresponding to the peripheral of the sealant 50, followed by curing the conductive adhesive 60. The curing of the conductive adhesive 60 may be carried out by thermal curing and/or ultra-violet (UV) curing.

In step S230, the display panel is treated, and the precursor layer reacts with the alignment layer to form bonds therebetween so as to control the liquid crystal molecules in the liquid crystal layer to be pre-tilted.

For example, the treating performed on the display panel may be carried out by applying a voltage to the display panel and irradiating with a light source. The light source used in irradiation can be an ultra-violet light or a visible light. Through the treatment of voltage applying and irradiation, the precursor layer 30 is controlled to react with the alignment layer 20 to form bonds therebetween, such that the liquid crystal molecules in the liquid crystal layer 40 are controlled to be tiled at a predetermined angle.

Optionally, when the precursor layer 30 is controlled to react with the alignment layer 20 to form bonds therebetween and the liquid crystal layer 40 is controlled to be pre-tilted, in detail, it can be the first precursor layer 30a to react with the second alignment layer 20b and/or is the second precursor layer 30b to react with the first alignment layer 20a to form the bonding grids 302. Through the bonding grids 302, the liquid crystal molecules are controlled to be tilted at a predetermined angle.

Please refer to FIG. 5b. FIG. 5b is a schematic diagram showing that the precursor layer reacts with the alignment layer to form bonds therebetween and the liquid crystal layer is controlled to be pre-tilted according to the present embodiment of this disclosure. As shown in FIG. 5b, a voltage is applied across the liquid crystal layer 40, and the liquid crystal molecules rotate. While the voltage is continuously applied across the liquid crystal layer 40, the display panel is irradiated. Since the functional monomers 301 forming the precursor layer 30 are photosensitive, the first precursor layer 30a then reacts with the second alignment layer 20b, and/or the second precursor layer 30b can react with the first alignment layer 20a to form bonds therebetween in the irradiation process, so as to form the bonding grids 302 for controlling the liquid crystal molecules therein to be pre-titled at the predetermined angle. It should be noted that FIG. 5b only schematically depicts that the precursor layer 30 reacts with the alignment layer 20 to form the bonding grids 302.

Optionally, the tilting of the liquid crystal molecules at the predetermined angle is controlled by the irradiation intensity and/or exposure time.

According to the method for manufacturing the display panel provided by the present embodiment of this disclosure, the display panel is obtained through forming the liquid crystal layer 40 between the first substrate 1 and the second substrate 2, and is then treated to ensure that the precursor layer 30 to react with the alignment layer 20 to form bonds therebetween. The liquid crystal molecules in the liquid crystal layer 40 is controlled to be tilted at the predetermined angle. In the aforementioned technical plan, the first substrate 1 and/or the second substrate 2 are/is fabricated by the aforementioned method for manufacturing the substrate provided by the preceding embodiment. Through the voltage applying and irradiation, the precursor layer 30 will react with the alignment layer 20 to form the bonding grids 302, and the liquid crystal molecules between the bonding grids 302 is controlled to be tilted at the predetermined angle. In the process for controlling the liquid crystal molecules in the liquid crystal layer 40 to be pre-tilted, the precursor layer 30 disposed on the surface of the alignment layer 20 will react directly with the alignment layer 20. Since the precursor layer 30 is directly formed on the surface of the alignment layer 20, the precursor layer 30 is uniformly distributed, so as to in turn ensure that the liquid crystal molecules are aligned homogeneously.

Please also refer to FIG. 5a, this disclosure further provides another embodiment which is a display panel. The display penal is fabricated through the aforementioned method for manufacturing the display panel in the preceding embodiment, and may specifically comprise a first substrate 1, a second substrate 2 and a liquid crystal layer 40. The first substrate 1 and the second substrate 2 are disposed opposite to each other. The first substrate 1 comprises a first substrate body 10a and a first alignment layer 20a. The first alignment layer 20a is formed on the surface of the first substrate body 10a. The second substrate 2 comprises a second substrate body 10b and a second alignment layer 20b which is formed on the surface of the second substrate body 10b. The liquid crystal layer 40 is disposed between the first substrate 1 and the second substrate 2. The first substrate 1 further comprises a first precursor layer 30a which is disposed on the surface of the first alignment layer 20a away from one side of the first substrate body 10a, and/or the second substrate 2 further comprises a second precursor layer 30b which is disposed on the surface of the second alignment layer 20b away from one side of the second substrate body 10b.

Optionally, the display panel may further comprise a sealant 50 disposed on the peripheral of the liquid crystal layer 40 and a conductive adhesive 60 disposed on the peripheral of the sealant 50.

The display panel according to the present embodiment of this disclosure is fabricated through the aforementioned method for manufacturing the display panel provided by the preceding embodiment, and has those corresponding useful effects which are omitted here.

This disclosure further provides another embodiment about a method for manufacturing a display panel. This method comprises the following steps: providing a first substrate body and a second substrate body; forming a first alignment layer on the first substrate body; cleaning the first alignment layer with a cleaning agent supplied with functional monomers, and the functional monomers (also referred to as reactive monomers) are attached to the surface of the first alignment layer to form a first leading material layer after the first alignment layer is cleaned; forming a liquid crystal layer on the first leading material layer by way of one drop filling (ODF); adhering the first substrate body to the second substrate body by a sealant, and the first substrate body, the second substrate body and the sealant form a closed space and the first precursor layer and the liquid crystal layer are disposed in the closed space; applying a first voltage between the first substrate body and the second substrate body; and, irradiating the liquid crystal layer and the first leading material layer with a first light source.

Optionally, the functional monomers are made of photosensitive materials.

Optionally, the functional monomers comprises at least one species of the following materials: acrylates, acrylate derivatives, methacrylates, methacrylate derivatives, styrenes, styrene derivatives and epoxy resins.

Optionally, the first light source is configured to provide visible light.

Optionally, the first light source is configured to provide ultra-violet light.

Optionally, the method for manufacturing the display panel further comprises the following steps: forming a second alignment layer on the second underlay; and cleaning the second alignment layer with a cleaning agent supplied with functional monomers, and the functional monomers are attached to a surface of the second alignment layer to form a second leading material layer after the second alignment layer is cleaned.

Optionally, the method for manufacturing the display panel further comprises: curing the sealant by ultra-violet light.

Optionally, adhering of the first substrate body to the second substrate body by the sealant is carried out in a vacuum chamber.

This disclosure still further provides another method for manufacturing a display panel. This method comprises the following steps: providing a first substrate body and a second substrate body; forming a first alignment layer on the first substrate body; cleaning the first alignment layer; forming a layer of functional monomers on the first alignment layer after the first alignment layer is cleaned; forming a liquid crystal layer by way of one drop filling; adhering the first substrate body to the second substrate body by a sealant, and the first substrate body, the second substrate body and the sealant form a closed space, and the first alignment layer, the functional monomer layer and the liquid crystal layer are disposed in the closed space; applying a first voltage between the first substrate body and the second substrate body; and, irradiating the liquid crystal layer and the layer of the functional monomers by a first light source.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A method for manufacturing a substrate, comprising:
forming an alignment layer on a surface of an substrate body; and
forming a precursor layer on a surface of the alignment layer away from the substrate body, wherein the precursor layer reacts with the alignment layer to form bonds therebetween.

2. The method according to claim 1, further comprising,:
cleaning the alignment layer after the alignment layer is formed.

3. The method according to claim 2, wherein forming the precursor layer on the surface of the alignment layer away from the substrate body comprises:
supplying functional monomers to a cleaning agent during cleaning the alignment layer; and
treating the functional monomers such that the functional monomers are assembled on the surface of the alignment layer to form the precursor layer.

4. The method according to claim 2, wherein forming the precursor layer on the surface of the alignment layer away from the substrate body comprises:
treating the surface of the alignment layer after the alignment layer is cleaned, and supplying functional monomers to the surface of the alignment layer; and
treating the functional monomers such that the functional monomers are assembled on the surface of the alignment layer to form the precursor layer.

5. The method according to claim 3, wherein the functional monomers are made of photosensitive materials.

6. The method according to claim 5, wherein the functional monomers comprises at least one species of materials which are selected from the group consisting of acrylate, acrylate derivatives, methacrylate, methacrylate derivatives, styrene, styrene derivatives and an epoxy resin.

7. The method according to claim 4, wherein the functional monomers are photosensitive materials.

8. The method according to claim 7, wherein the functional monomers comprises at least one species of materials which is selected from the group consisting of acrylate, acrylate derivatives, methacrylate, methacrylate derivatives, styrene, styrene derivatives and an epoxy resin.

9. A display panel, comprising:
a first substrate comprising a first substrate body and a first alignment layer formed on the first substrate body;
a second substrate disposed opposite to the first substrate, wherein the second substrate comprises a second substrate body and a second alignment layer formed on the second substrate body; and
a liquid crystal layer disposed between the first substrate and the second substrate;
wherein the first substrate further comprises a first precursor layer disposed on a surface of the first alignment layer away from the first substrate body, and the second substrate further comprises a second precursor layer disposed on a surface of the second alignment layer away from the second substrate body.

10. The display panel according to claim 9, wherein both the first precursor layer and the second precursor layer comprise functional monomers.

11. The display panel according to claim 10, wherein the functional monomers in the first precursor layer react with the first alignment layer to form bonds therebetween, and the functional monomers in the second precursor layer react with the second alignment layer to form bonds therebetween.

12. The display panel according to claim 10, wherein the functional monomers are made of photosensitive materials, and the functional monomers comprises at least one species of materials which is selected from the group consisting of acrylate, acrylate derivatives, methacrylate, methacrylate derivatives, styrene, styrene derivatives and an epoxy resin.

13. A method for manufacturing a display panel, comprising:
providing a first substrate body and a second substrate body;
forming a first alignment layer on the first substrate body;
cleaning the first alignment layer by a cleaning agent supplied with functional monomers, wherein the functional monomers are attached to a surface of the first alignment layer to form a first precursor layer after the first alignment layer is cleaned;
forming a liquid crystal layer on the first precursor layer by way of one drop filling (ODF);
adhering the first substrate body to the second substrate body by a sealant, wherein the first substrate body, the second substrate body and the sealant form a closed space, and the first precursor layer and the liquid crystal layer are disposed in the closed space;
applying a first voltage between the first substrate body and the second substrate body; and
irradiating the liquid crystal layer and the first precursor layer by a first light source.

14. The method according to claim 13, wherein the functional monomers are made of photosensitive materials.

15. The method according to claim 13, wherein the functional monomers comprises at least one species of materials which is selected from the group consisting of acrylate, acrylate derivatives, methacrylate, methacrylate derivatives, styrene, styrene derivatives and an epoxy resin.

16. The method according to claim 13, wherein the first light source is configured to provide visible light.

17. The method according to claim 13, wherein the first light source is configured to provide ultra-violet light.

18. The method according to claim 13, further comprising:
forming a second alignment layer on the second substrate body; and
cleaning the second alignment layer by a cleaning agent supplied with functional monomers, wherein the functional monomers are attached to a surface of the second alignment layer to form a second precursor layer after the second alignment layer is cleaned.

19. The method according to claim 13, further comprising: curing the sealant by ultra-violet light.

20. The method according to claim 13, wherein adhering the first substrate body to the second substrate body by the sealant is performed in a vacuum chamber.
